(19) United States
(12) Patent Application Publication
(10) Pub. No.: US 2023/0113899 A1
(43) Pub. Date: Apr. 13, 2023

(54) OPTICAL IMAGING SYSTEM

(71) Applicant: SAMSUNG ELECTRO-MECHANICS CO., LTD., Suwon-si (KR)

(72) Inventors: Joon Hee BYUN, Suwon-si (KR); Ho Sik YOO, Suwon-si (KR); Che Young LIM, Suwon-si (KR)

(73) Assignee: SAMSUNG ELECTRO-MECHANICS CO., LTD., Suwon-si (KR)

(21) Appl. No.: 17/678,462

(22) Filed: Feb. 23, 2022

(30) Foreign Application Priority Data
Oct. 12, 2021 (KR) 10-2021-0134820

(51) Int. Cl. G02B 13/00; G02B 9/14

(52) U.S. Cl. CPC G02B 13/0035; G02B 9/14

(57) ABSTRACT

An optical imaging system includes a lens group including at least one lens forming a first optical axis; and an optical path converter reflecting light emitted from the lens group to form an image on an imaging plane. In the optical imaging system, a maximum distance from an object side surface of a frontmost lens, disposed closest to an object side, among the lens group, to the imaging plane, in a first optical axis direction is 11.0 mm or less.

### CROSS REFERENCE TO RELATED APPLICATIONS

This application claims the benefit under 35 USC 119(a) of Korean Patent Application No. 10-2021-0134820 filed on Oct. 12, 2021, in the Korean Intellectual Property Office, the entire disclosure of which is incorporated herein by reference for all purposes.

### BACKGROUND

### 1. Field

The present disclosure relates to an optical imaging system, and an optical imaging system including one or more optical path converters.

### 2. Description of the Background

A portable electronic device may include a camera module. For example, a portable electronic device such as a notebook computer, a smartphone, or the like may include a camera module for videoconferencing, videotelephony, or the like. Meanwhile, as performance of a portable electronic device is improved, demand for a camera module having high resolution is increasing. For example, an image sensor of a camera module is gradually being enlarged to facilitate implementation of high resolution. However, since the enlargement of the image sensor increases an overall length of the optical imaging system constituting the camera module (i.e., a distance from an object side surface of a frontmost lens to an imaging plane), there may be a problem preventing miniaturization and thinning of the camera module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a lens group including at least one lens forming a first optical axis, and an optical path converter reflecting light emitted from the lens group to form an image on an imaging plane, wherein a maximum distance from an object side surface of a frontmost lens, disposed closest to an object side, among the lens group, to the imaging plane, in a first optical axis direction, is 11.0 mm or less.

The lens group may include a first lens, a second lens, and a third lens, sequentially arranged from the object side.

The first lens may have positive refractive power.

The second lens may have negative refractive power.

The second lens may have a concave object side surface.

The second lens may have a concave image side surface.

The third lens may have positive refractive power.

A distance of an optical path from an image side surface of a rearmost lens, a lens disposed closest to the imaging plane, among the lens group, to the imaging plane may be 20.0 mm to 50.0 mm.

The following conditional expression, 0.86 < BFL/TTL < 0.96, may be satisfied, where TTL is a distance of an optical path from the object side surface of the frontmost lens to the imaging plane, and BFL is a distance of an optical path from an image side surface of a rearmost lens among the lens group to the imaging plane.

The first optical axis direction and an optical axis of the imaging plane may be substantially parallel.

In another general aspect, an optical imaging system includes a lens group including at least one lens, and an optical path converter disposed between the lens group and an imaging plane, and configured to reflect light emitted from the lens group one or more times, to form an image on the imaging plane by the light, wherein 8 < f/IMG HT < 12, where f is a focal length of the optical imaging system, and IMG HT is a height of the imaging plane.

The following conditional expression, 0.30 < f1/f < 0.40, may be satisfied, where f1 is a focal length of the first lens.

The following conditional expression, -0.28 < f2/f < -0.18, may be satisfied, where f2 is a focal length of the second lens.

The following conditional expression, 0.40 < f3/f < 0.50, may be satisfied, where f3 is a focal length of the third lens.

The following conditional expression, 1.68 < (Nd1+Nd2+Nd3)/3 < 1.74, may be satisfied, where Nd1 is a refractive index of the first lens, Nd2 is a refractive index of the second lens, and Nd3 is a refractive index of the third lens.

A maximum distance from an object side surface of a frontmost lens, disposed closest to an object side, among the lens group, to the imaging plane, in an optical axis direction of the lens group may be 11.0 mm or less.

In another general aspect, an optical imaging system includes a lens group including at least one lens, and an optical path converter disposed between the lens group and an imaging plane, and configured to reflect light emitted from the lens group two or more times, to form an image on the imaging plane by the light, wherein 1.0 < BFL/f < 1.6, where f is a focal length of the optical imaging system, and BFL is a distance of an optical path from an image side surface of a rearmost lens among the lens group to the imaging plane.

An optical axis of the at least one lens and an optical axis of the imaging plane may be substantially parallel.

Other features and aspects will be apparent from the following detailed description, the drawings, and the claims.

### BRIEF DESCRIPTION OF DRAWINGS

FIG. 1 is a configuration diagram of an optical imaging system according to a first embodiment of the present disclosure.

FIGS. 2 and 3 are aberration curves of the optical imaging system illustrated in FIG. 1.

FIG. 4 is a configuration diagram of an optical imaging system according to a second embodiment of the present disclosure.

FIG. 5 is an aberration curve of the optical imaging system illustrated in FIG. 4.

FIG. 6 is a configuration diagram of an optical imaging system according to a third embodiment of the present disclosure.

FIG. 7 is an aberration curve of the optical imaging system illustrated in FIG. 6.

FIG. 8 is a configuration diagram of an optical imaging system according to a fourth embodiment of the present disclosure.

FIG. 9 is an aberration curve of the optical imaging system illustrated in FIG. 8.

FIG. 10 is a configuration diagram of an optical imaging system according to a fifth embodiment of the present disclosure.

FIG. 11 is a view schematically illustrating an optical path according to the first optical path converter and the second optical path converter illustrated in FIG. 10.

FIG. 12 is an aberration curve of the optical imaging system illustrated in FIG. 10.

FIG. 13 is a perspective view of a portable electronic device including an optical imaging system according to an embodiment of the present disclosure.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

Hereinafter, while example embodiments of the present disclosure are described in detail with reference to the accompanying illustrative drawings, it is noted that examples are not limited to the same.

In the following description of the present disclosure, terms referring to the components of the present disclosure may be named in consideration of the function of each component, and should not be understood as a meaning limiting the technical components of the present disclosure.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure

Herein, it is noted that use of the term “may” with respect to an example or embodiment, for example, as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” “lower,” and the like, may be used herein for ease of description to describe one element’s relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element would then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after gaining an understanding of this disclosure. Further, although the examples described herein have a variety of configurations, other configurations are possible as will be apparent after gaining an understanding of this disclosure.

An aspect of the present disclosure is to provide an optical imaging system that may be mounted on a portable electronic device, regardless of a size of an image sensor and an optical path length of the optical imaging system.

In addition, in the present specification, a first lens refers to a lens most adjacent to an object (or a subject), and a third lens refers to a lens most adjacent to an imaging plane (or an image sensor). In the present specification, units of a radius of curvature, a thickness, a TTL (a distance from an object-side surface of the first lens to an imaging plane), an IMG_HT (a height of an imaging plane), and a focal length are indicated in millimeters (mm). In addition, a thickness of a lens, a distance between lenses, a TTL, a BFL (a distance from an image-side surface of the rearmost lens closest to the image sensor to the imaging plane), and an optical path may be distances measured based on a center of an optical axis of the lens. In addition, in the descriptions of a shape of a lens, a configuration in which one surface is convex indicates that an optical axis region of the surface is convex, and a configuration in which one surface is concave indicates that an optical axis region of the surface is concave. Thus, even when it is described that one surface of a lens is convex, an edge of the lens may be concave. Similarly, even when it is described that one surface of a lens is concave, an edge of the lens may be convex.

An optical imaging system described in the present specification may be configured to be mounted on a portable electronic device. For example, the optical imaging system may be mounted on a smartphone, a notebook computer, an augmented reality device, a virtual reality device (VR), a portable game machine, or the like. Ranges and examples of use of an optical imaging system described in this specification are not limited to the above-described electronic devices. For example, the optical imaging system provides a narrow mounting space, but may be applied to an electronic device requiring high-resolution imaging.

An optical imaging system according to a first aspect of the present disclosure may include a lens group and an optical path converter. The lens group may include at least one lens. For example, the lens group may include a first lens, a second lens, and a third lens, sequentially arranged along a first optical axis from an object side. The number of lenses constituting the lens group is not limited to three. For example, the lens group may include four or more lenses. As another example, the lens group may be comprised of two or less lenses. The lens group may be configured to form one optical axis. For example, the lenses of the lens group may be sequentially disposed along the first optical axis. The optical path converter may be configured to convert or change an optical path of the optical imaging system. For example, the optical path converter may convert an optical path formed along the first optical axis in a direction intersecting the first optical axis. As a specific example, the optical path converter may convert the optical path to form an image on an imaging plane with light emitted from the lens group.

The optical imaging system according to the first aspect may be configured to be mounted on a portable electronic device while having an optical path of a considerable size. For example, the optical path of the optical imaging system (a distance from an object side surface of a frontmost lens among the lens group to an imaging plane: TTL) may be greater than a thickness of the portable electronic device, but an external height of the optical imaging system may be less than the thickness of the portable electronic device. As a specific example, a maximum distance from an object side surface of a frontmost lens among the lens group to the imaging plane in a first optical axis direction may be 11.0 mm or less.

An optical imaging system according to a second aspect may include a lens group and an optical path converter. The lens group may include at least one lens. For example, the lens group may include a first lens, a second lens, and a third lens, sequentially arranged along a first optical axis from an object side. The number of lenses constituting the lens group is not limited to three. For example, the lens group may include four or more lenses. As another example, the lens group may be comprised of two or less lenses. The optical path converter may be disposed between the lens group and an imaging plane, and may be configured to reflect light emitted from the lens group one or more times. For example, the optical path converter may reflect the light emitted from the lens group once in a direction intersecting the first optical axis. As another example, the optical path converter may reflect the light emitted from the lens group twice in a direction intersecting the first optical axis. As another example, the optical path converter may reflect the light emitted from the lens group in a direction intersecting and parallel to the first optical axis.

The optical imaging system according to the second aspect may form a specific numerical relationship between a focal length f and an image height IMG HT (a height of the imaging plane). For example, the optical imaging system according to the second aspect may satisfy 8.0 < f/IMG HT < 12.0.

The optical path converter according to the present specification may include a prism. For example, the optical path converter may include one prism or two or more prisms. As another example, the optical path converter may include one Pechan prism or one or more prisms and one or more Pechan prisms. A configuration of the optical path converter is not limited to the prism and the Pechan prism. For example, the optical path converter may include a reflector.

An optical imaging system according to the present specification may satisfy one or more of the following conditional expressions. For example, the optical imaging systems according to the first aspect and the second aspect may satisfy one or more of the following conditional expressions.
10.0 mm < TOH < 12.0 mm
21.5 mm < TOL < 31.0 mm
7.50 mm < TOW < 16.5 mm
6.0 mm < PEH < 7.0 mm
6.0 mm < PEL < 8.5 mm
11.0 mm < PEW < 13.0 mm
0.05 mm < DPE12
0.1 mm < DPEP
0.2 mm < DLRP1 < 1.0 mm
2.8 mm < P1W < 5.0 mm
2.8 mm < P1H < 5.0 mm
0.05 mm < DPA

In the above conditional expressions, TOH is a maximum length of an optical imaging system in a first optical axis direction, TOL is a maximum length of the optical imaging system in a second optical axis direction (in a direction intersecting a first optical axis and extending in an imaging plane direction), TOW is a maximum length of the optical imaging system in a third optical axis direction (in a direction intersecting first and second optical axes, respectively), PEH is a first optical axis direction length of Pechan prisms constituting an optical path converter, PEL is a length of the Pechan prisms constituting the optical path converter in the second optical axis direction, PEW is a length of the Pechan prism constituting the optical path converter in the third optical axis direction, DPE12 is a distance from an exit surface of a first Pechan prism to an incident surface of a second Pechan prism, constituting the optical path converter, DPEP is a distance between the Pechan prisms constituting the optical path converter (for example, a distance from an exit surface of a prism to an incident surface of Pechan prism disposed on an image-side of the prism, or a distance from an exit surface of Pechan prism to an incident surface of a prism disposed on an image-side of the Pechan prism), DLRP1 is a distance from the image side surface of a rearmost lens in a lens group to an incident surface of a frontmost prism of the optical path converter, P1W is a length of prisms constituting the optical path converter in the third optical axis direction, P1H is a length of the prisms constituting the optical path converter in the second optical axis direction, and DPA is a distance from an exit surface of a first prism to an incident surface of a second prism, constituting the optical path converter.

An optical imaging system may satisfy some of the above-described conditional expressions in a more limited form as follows:
0.05 mm < DPE12 < 0.1 mm
0.1 mm < DPEP < 0.2 mm
0.05 mm < DPA < 0.1 mm

An optical imaging system according to the present specification may further satisfy one or more of the following conditional expressions, regardless of the above-described conditional expressions. As an example, the optical imaging system may satisfy one or more of the following conditional expressions while satisfying one or more of the above-described conditional expressions. As another example, the optical imaging system may satisfy one or more of the following conditional expressions, regardless of whether the above-described conditional expressions are satisfied:
1.0 < TTL/f < 1.7
0.86 < BFL/TTL < 0.96
0.30 < f1/f < 0.40
-0.28 < f2/f < -0.18
0.40 < f3/f < 0.50
1.0 < BFL/f < 1.6
1.68 < (Nd1+Nd2+Nd3)/3 < 1.74
1.0 < TTL/BFL < 1.20
20.0 mm < BFL < 50.0 mm

In the above conditional expressions, TTL is a length from an object side surface of a frontmost lens (a first lens) of a lens group to an imaging plane, f is a focal length of the optical imaging system, BFL is a distance from an image side surface of a rearmost lens (a third lens) of the lens group to the imaging plane, f1 is a focal length of a first lens, f2 is a focal length of a second lens, f3 is a focal length of a third lens, Nd1 is a refractive index of the first lens, Nd2 is a refractive index of the second lens, and Nd3 is a refractive index of the third lens.

The optical imaging system according to the present specification may include one or more lenses having the following characteristics, as necessary. For example, the optical imaging system according to the first aspect may include one of the first to third lenses according to the following characteristics. As another example, the optical imaging system according to the second aspect may include two or more of the first to third lenses according to the following characteristics. An optical imaging system according to the above-described aspect may not necessarily include a lens according to the following characteristics. Hereinafter, characteristics of the first to third lenses will be described.

The first lens may have refractive power. For example, the first lens may have positive refractive power. The first lens may include a spherical surface or an aspherical surface. For example, both surfaces of the first lens may be aspherical. The first lens may be made of a material having high light transmittance and excellent workability. For example, the first lens may be made of a plastic material or a glass material. The first lens may be configured to have a predetermined refractive index. For example, a refractive index of the first lens may be greater than 1.7. As a specific example, the refractive index of the first lens may be greater than 1.70 and less than 1.80. The first lens may have a predetermined Abbe number. For example, the Abbe number of the first lens may be 40 or greater. As a specific example, the Abbe number of the first lens may be greater than 40 and less than 50.

The second lens may have refractive power. For example, the second lens may have negative refractive power. The second lens may have a shape in which one surface is concave. For example, the second lens may have a concave object side surface. As another example, the second lens may have a concave image side surface. The second lens may include a spherical surface or an aspherical surface. For example, both surfaces of the second lens may be aspherical. The second lens may be made of a material having high light transmittance and excellent workability. For example, the second lens may be made of a plastic material or a glass material. The second lens may be configured to have a predetermined refractive index. For example, a refractive index of the second lens may be greater than 1.6. As a specific example, the refractive index of the second lens may be greater than 1.60 and less than 1.70. The second lens may have predetermined Abbe number. For example, Abbe number of the second lens may be 30 or greater. As a specific example, the Abbe number of the second lens may be greater than 20 and less than 40.

The third lens may have refractive power. For example, the third lens may have positive refractive power. The third lens may include a spherical surface or an aspherical surface. For example, both surfaces of the third lens may be aspherical. The third lens may be made of a material having high light transmittance and excellent workability. For example, the third lens may be made of a plastic material or a glass material. The third lens may be configured to have a predetermined refractive index. For example, a refractive index of the third lens may be greater than 1.7. As a specific example, the refractive index of the third lens may be greater than 1.70 and less than 1.80. The third lens may have predetermined Abbe number. For example, Abbe number of the third lens may be 40 or more. As a specific example, the Abbe number of the third lens may be greater than 40 and less than 50.

A plurality of lenses may be made of a material having a refractive index different from that of air. For example, many lenses may be made of a plastic material or a glass material. At least one of the plurality of lenses may have an aspherical shape. The aspherical shape of the lens may be expressed by Equation 1.

$$\begin{matrix}Z = \frac{c {r}^{2}}{1 + \sqrt{1 - \left(1 + k\right) {c}^{2} {r}^{2}}} + A {r}^{4} + B {r}^{6} + C {r}^{8} + D {r}^{10} + E {r}^{12} + \\ F {r}^{14} + G {r}^{16} + H {r}^{18} + J {r}^{20}\end{matrix}$$

In Equation 1, c is the reciprocal of a radius of curvature of a corresponding lens, k is a conic constant, r is a distance from any point on the aspherical surface to an optical axis, A to H and J are aspherical surface constants, and Z (or SAG) is a height in an optical axis direction from a certain point on the aspherical surface to a vertex of the corresponding aspherical surface.

An optical imaging system according to the present specification may include a filter and a stop.

The filter may be disposed between a lens group and an optical path converter or between the optical path converter and an imaging plane. The filter may block some wavelengths from incident light, to improve resolution of the optical imaging system. For example, the filter may block infrared wavelengths of incident light. The stop may be disposed between a lens and a lens or between the lens group and the optical path converter. The stop may be omitted, as necessary.

An optical imaging system according to the present specification may further include a spacing member. The spacing member may be disposed between a lens and a lens, between a lens group and an optical path converter, or between the optical path converter and an imaging plane.

Next, a specific embodiment of an optical imaging system will be described with reference to the drawings.

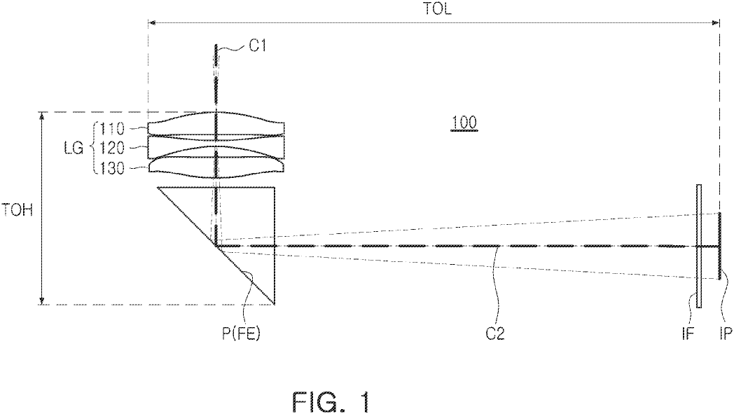

First, an optical imaging system according to a first embodiment will be described with reference to FIG. 1.

An optical imaging system 100 may include a lens group LG and an optical path converter FE. A configuration of the optical imaging system 100 is not limited to the lens group LG and the optical path converter FE. For example, the optical imaging system 100 may further include a filter IF disposed between the optical path converter FE and an imaging plane IP.

The lens group LG may include a plurality of lenses. For example, the lens group LG may include a first lens 110, a second lens 120, and a third lens 130, sequentially arranged from an object side. A configuration of the lens group LG is not limited to the first lens 110 to the third lens 130. For example, the lens group LG may consist only of the first lens 110 and the second lens 120. As another example, the lens group LG may be configured to include the first lens 110 to a fourth lens (not illustrated).

The first lens 110 may have positive refractive power. The first lens 110 may have a convex object side surface and a convex image side surface. The second lens 120 may have negative refractive power. The second lens 120 may have a concave object side surface and a concave image side surface. The third lens 130 may have positive refractive power. The third lens 130 may have a convex object side surface and a convex image side surface.

The optical path converter FE may include a prism P. The prism P may be disposed between the lens group LG and the imaging plane IP. The prism P may be configured to convert an optical path of the lens group LG. For example, the prism P may convert a path of light incident along a first optical axis C1 in a direction of a second optical axis C2.

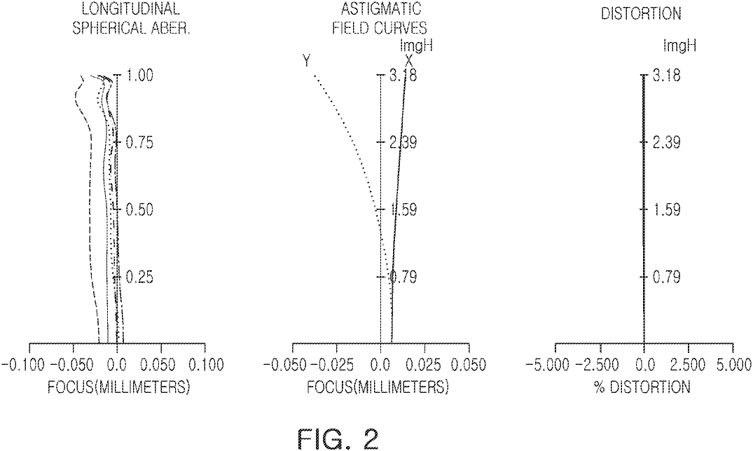

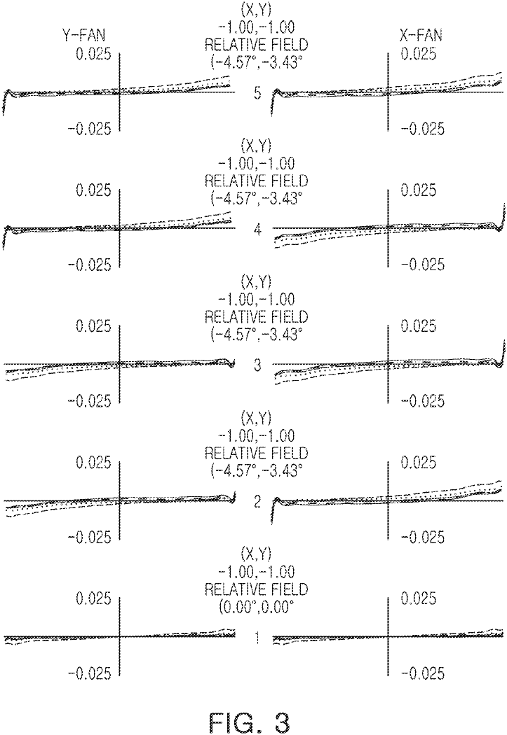

Table 1 illustrates lens characteristics of the optical imaging system according to the present embodiment, and Table 2 illustrates aspheric surface values of the optical imaging system according to the present embodiment. FIGS. 2 and 3 are aberration curves of the optical imaging system 100 according to the present embodiment.

TABLE 1

| Surface No. | Curvature Radius | Thickness/Dist ance | Glass Code | Y Semi-Aperture | X Semi-Aperture | Component |
|---|---|---|---|---|---|---|
| S1 | 7.6294 | 1.2150 | 743972.4485 | 3.2609 | 3.2609 | 1st Lens |
| S2 | -117.7929 | 0.3000 | | 3.3131 | 3.3131 | |
| S3 | -10.2950 | 0.3200 | 637777.3464 | 3.3097 | 3.3097 | 2nd Lens |
| S4 | 6.8799 | 0.5688 | | 3.2562 | 3.2562 | |
| S5 | 117.5235 | 1.0962 | 743972.4485 | 3.2644 | 3.2644 | 3rd Lens |
| S6 | -11.0483 | 0.5000 | | 3.2294 | 3.2294 | |
| S7 | infinity | 3.1500 | 721743.2950 | 3.0000 | 4.0000 | Prism |
| S8 | infinity | 3.1500 | 721743.2950 | 4.2426 | 4.0000 | |
| S9 | infinity | 22.6055 | | 3.0000 | 4.0000 | |
| S10 | infinity | 0.2100 | 518274.6417 | 3.0000 | 4.0000 | Filter |
| S11 | infinity | 1.0000 | | 2.9977 | 2.9977 | |
| S12 | infinity | -0.0066 | | 3.0094 | 3.0094 | Imaging plane |

TABLE 2

| | | | | | | |
|---|---|---|---|---|---|---|
| Surface No. | S1 | S2 | S3 | S4 | S5 | S6 |
| K | 0.0000E+00 | 0.0000E+00 | 0.0000E+00 | 2.1678E+00 | 0.0000E+00 | 0.0000E+00 |
| A | -7.4221E-04 | 8.2934E-04 | 4.0013E-03 | -2.7423E-03 | -2.7352E-03 | -4.2059E-04 |
| B | -8.9399E-06 | 2.4474E-05 | -3.1930E-04 | 1.8195E-05 | 2.8005E-04 | 7.0287E-05 |
| C | 4.4126E-06 | 4.2472E-06 | 2.4431E-05 | -1.1984E-05 | -4.2723E-06 | 5.6261E-06 |
| D | -8.2480E-07 | -8.5384E-07 | -7.6642E-07 | 8.1628E-07 | 8.2474E-07 | 3.7637E-07 |

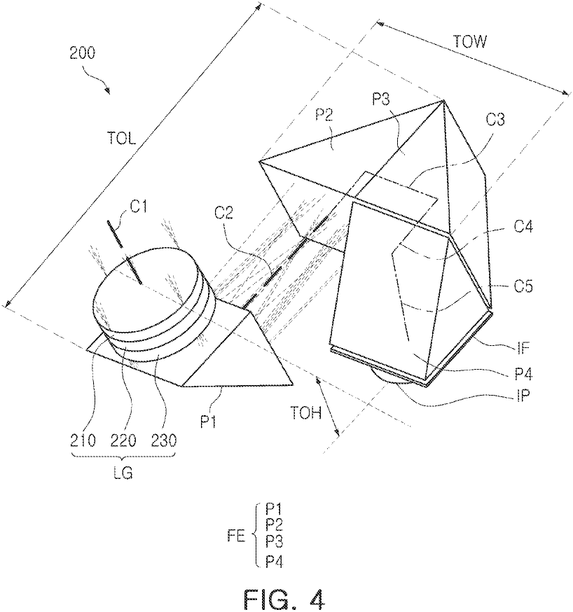

An optical imaging system according to a second embodiment will be described with reference to FIG. 4.

An optical imaging system 200 may include a lens group LG and an optical path converter FE. A configuration of the optical imaging system 200 is not limited to the lens group LG and the optical path converter FE. For example, the optical imaging system 200 may further include a filter IF disposed between the optical path converter FE and an imaging plane IP.

The lens group LG may include a plurality of lenses. For example, the lens group LG may include a first lens 210, a second lens 220, and a third lens 230, sequentially arranged from an object side. A configuration of the lens group LG is not limited to the first lens 210 to the third lens 230. For example, the lens group LG may consist only of the first lens 210 and the second lens 220. As another example, the lens group LG may be configured to include the first lens 210 to a fourth lens (not illustrated).

The first lens 210 may have positive refractive power. The first lens 210 may have a convex object side surface and a convex image side surface. The second lens 220 may have negative refractive power. The second lens 220 may have a concave object side surface and a concave image side surface. The third lens 230 may have positive refractive power. The third lens 230 may have a convex object side surface and a convex image side surface.

The optical path converter FE may include a plurality of prisms (P1, P2, P3, and P4). For example, the optical path converter FE may be comprised of a first prism P1, a second prism P2, a third prism P3, and a fourth prism P4. The first prism P1 to the fourth prism P4 may be disposed between the lens group LG and the imaging plane IP.

The first prism P1 to the fourth prism P4 may be configured to convert an optical path of the lens group LG. In more detail, the first prism P1 to the fourth prism P4 may convert an optical path of incident light in different directions. For example, the first prism P1 may reflect light incident along a first optical axis C1 in a direction of a second optical axis C2, the second prism P2 may reflect light incident along the second optical axis C2 in a direction of a third optical axis C3, the third prism P3 may reflect light incident along the third optical axis C3 in a direction of a fourth optical axis C4, and the fourth prism P4 may reflect the light incident along the fourth optical axis C4 in the direction of a fifth optical axis C5 (i.e., in a direction of the imaging plane).

The first to fourth prisms P1 to P4 may be configured to reflect incident light in a direction intersecting the incident light direction. For example, the second optical axis C2 may be formed in a direction intersecting the first optical axis C1, the third optical axis C3 may be formed in a direction intersecting the second optical axis C2, and the fourth optical axis C4 may be formed in a direction intersecting the third optical axis C3, and the fifth optical axis C5 may be formed in a direction intersecting the fourth optical axis C4.

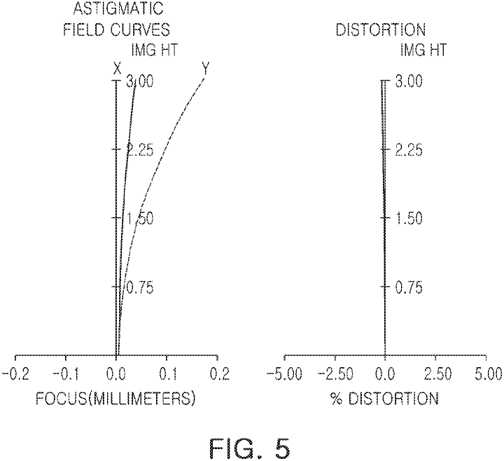

Table 3 illustrates lens characteristics of the optical imaging system according to the present embodiment, and Table 4 illustrates aspheric surface values of the optical imaging system according to the present embodiment. FIG. 5 is an aberration curve of the optical imaging system 200 according to the present embodiment.

TABLE 3

| Surface No. | Curvature Radius | Thickness/Dist ance | Glass code | Y Semi-Aperture | X Semi-Aperture | Component |
|---|---|---|---|---|---|---|
| S1 | 7.6294 | 1.2150 | 743972.4485 | 3.2609 | 3.2609 | 1st Lens |
| S2 | -117.7929 | 0.3000 | | 3.2504 | 3.2504 | |
| S3 | -10.2950 | 0.3200 | 637777.3464 | 3.2479 | 3.2479 | 2nd Lens |
| S4 | 6.8799 | 0.5688 | | 3.2040 | 3.2040 | |
| S5 | 117.5235 | 1.0962 | 743972.4485 | 3.2119 | 3.2119 | 3rd Lens |
| S6 | -11.0483 | 0.5000 | | 3.1858 | 3.1858 | |
| S7 | infinity | 3.1500 | 721743.2950 | 3.0000 | 4.0000 | 1st Prism |
| S8 | infinity | 3.1500 | 721743.2950 | 4.2426 | 4.0000 | |
| S9 | infinity | 9.3000 | | 3.0000 | 4.0000 | |
| S10 | infinity | 4.0000 | 721743.2950 | 3.0000 | 4.0000 | 2nd Prism |
| S11 | infinity | 4.0000 | 721743.2950 | 3.0000 | 5.6569 | |
| S12 | infinity | 0.1000 | | 3.0000 | 4.0000 | |
| S13 | infinity | 4.0000 | 721743.2950 | 3.0000 | 4.0000 | 3rd Prism |
| S14 | infinity | 4.0000 | 721743.2950 | 3.0000 | 5.6569 | |
| S15 | infinity | 0.1000 | | 3.0000 | 4.0000 | |
| S16 | infinity | 3.0000 | 721743.2950 | 2.8000 | 3.8000 | 4th Prism |
| S17 | infinity | 3.0000 | 721743.2950 | 3.9598 | 3.8000 | |
| S18 | infinity | 0.3000 | | 2.8000 | 3.8000 | |
| S19 | infinity | 0.2100 | 518274.6417 | 3.0000 | 4.0000 | Filter |
| S20 | infinity | 1.0278 | | 2.9943 | 2.9943 | |
| S21 | infinity | -0.0066 | | 3.0075 | 3.0075 | Imaging plane |

TABLE 4

| | | | | | | |
|---|---|---|---|---|---|---|
| Surface No. | S1 | S2 | S3 | S4 | S5 | S6 |
| K | 0.0000E+00 | 0.0000E+00 | 0.0000E+00 | 2.1678E+00 | 0.0000E+00 | 0.0000E+00 |
| A | -7.4221E-04 | 8.2934E-04 | 4.0013E-03 | -2.7423E-03 | -2.7352E-03 | -4.2059E-04 |
| B | -8.9399E-06 | 2.4474E-05 | -3.1930E-04 | 1.8195E-05 | 2.8005E-04 | 7.0287E-05 |
| C | 4.4126E-06 | 4.2472E-06 | 2.4431E-05 | -1.1984E-05 | -4.2723E-06 | 5.6261E-06 |
| D | -8.2480E-07 | -8.5384E-07 | -7.6642E-07 | 8.1628E-07 | 8.2474E-07 | 3.7637E-07 |

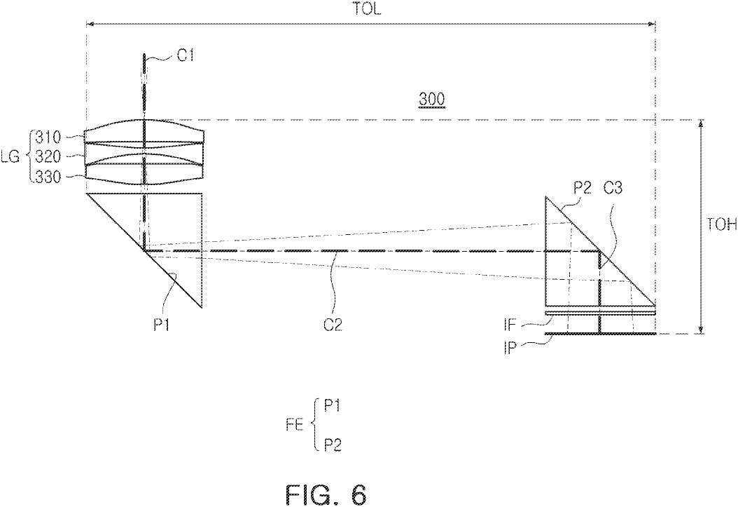

An optical imaging system according to a third embodiment will be described with reference to FIG. 6.

An optical imaging system 300 may include a lens group LG and an optical path converter FE. A configuration of the optical imaging system 300 is not limited to the lens group LG and the optical path converter FE. For example, the optical imaging system 300 may further include a filter IF disposed between the optical path converter FE and an imaging plane IP.

The lens group LG may include a plurality of lenses. For example, the lens group LG may include a first lens 310, a second lens 320, and a third lens 330, sequentially arranged from an object side. A configuration of the lens group LG is not limited to the first lens 310 to the third lens 330. For example, the lens group LG may consist only of the first lens 310 and the second lens 320. As another example, the lens group LG may be configured to include the first lens 310 to a fourth lens (not illustrated).

The first lens 310 may have positive refractive power. The first lens 310 may have a convex object side surface and a convex image side surface. The second lens 320 may have negative refractive power. The second lens 320 may have a concave object side surface and a concave image side surface. The third lens 330 may have positive refractive power. The third lens 330 may have a convex object side surface and a convex image side surface.

The optical path converter FE may include a plurality of prisms P1 and P2. For example, the optical path converter FE may be comprised of a first prism P1 and a second prism P2. The first prism P1 and the second prism P2 may be disposed between the lens group LG and the imaging plane IP.

The first prism P1 and the second prism P2 may be configured to convert an optical path of the lens group LG. In more detail, the first prism P1 and the second prism P2 may convert an optical path of incident light in a direction intersecting a first optical axis C1 or parallel to the first optical axis C1. For example, the first prism P1 may reflect light incident along the first optical axis C1 in a direction of a second optical axis C2, the second prism P2 may reflect light incident along the second optical axis C2 in a direction of a third optical axis C3 (i.e., in a direction of the imaging plane).

The first prism P1 and the second prism P2 may be configured to reflect incident light in a direction intersecting the incident light direction. For example, the second optical axis C2 may be formed in a direction intersecting the first optical axis C1, and the third optical axis C3 may be formed in a direction intersecting the second optical axis C2.

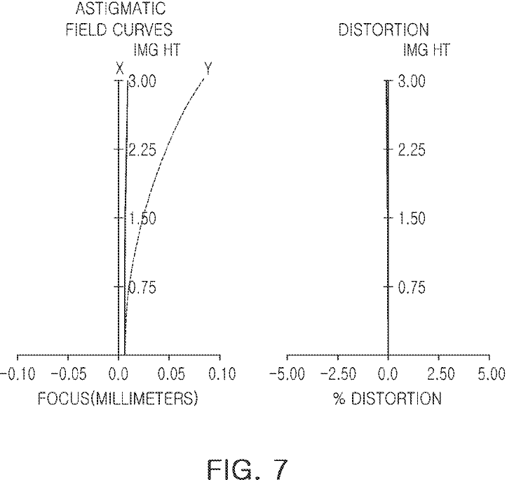

Table 5 illustrates lens characteristics of the optical imaging system according to the present embodiment, and Table 6 illustrates aspheric surface values of the optical imaging system according to the present embodiment. FIG. 7 is an aberration curve of the optical imaging system 300 according to the present embodiment.

TABLE 5

| Surface No. | Curvature Radius | Thickness/ Distance | Glass code | Y Semi-Aperture | X Semi-Aperture | Component |
|---|---|---|---|---|---|---|
| S1 | 7.6294 | 1.2150 | 743972.4485 | 3.2609 | 3.2609 | 1st Lens |
| S2 | -117.7929 | 0.3000 | | 3.2504 | 3.2504 | |
| S3 | -10.2950 | 0.3200 | 637777.3464 | 3.2478 | 3.2478 | 2nd Lens |
| S4 | 6.8799 | 0.5688 | | 3.2039 | 3.2039 | |
| S5 | 117.5235 | 1.0962 | 743972.4485 | 3.2118 | 3.2118 | 3rd Lens |
| S6 | -11.0483 | 0.5000 | | 3.1857 | 3.1857 | |
| S7 | infinity | 3.1500 | 721743.2950 | 3.0000 | 4.0000 | 1st Prism |
| S8 | infinity | 3.1500 | 721743.2950 | 4.2426 | 4.0000 | |
| S9 | infinity | 18.8207 | | 3.0000 | 4.0000 | |
| S10 | infinity | 3.0000 | 721743.2950 | 2.8000 | 3.8000 | 2nd Prism |
| S11 | infinity | 3.0000 | 721743.2950 | 3.9598 | 3.8000 | |
| S12 | infinity | 0.3000 | | 2.8000 | 3.8000 | |
| S13 | infinity | 0.2100 | 518274.6417 | 3.0000 | 4.0000 | Filter |
| S14 | infinity | 1.0000 | | 2.9920 | 2.9920 | |
| S15 | infinity | -0.0066 | | 3.0047 | 3.0047 | Imaging plane |

TABLE 6

| | | | | | | |
|---|---|---|---|---|---|---|
| Surface No. | S1 | S2 | S3 | S4 | S5 | S6 |
| K | 0.0000E+00 | 0.0000E+00 | 0.0000E+00 | 2.1678E+00 | 0.0000E+00 | 0.0000E+00 |
| A | -7.4221E-04 | 8.2934E-04 | 4.0013E-03 | -2.7423E-03 | -2.7352E-03 | -4.2059E-04 |
| B | -8.9399E-06 | 2.4474E-05 | -3.1930E-04 | 1.8195E-05 | 2.8005E-04 | 7.0287E-05 |
| C | 4.4126E-06 | 4.2472E-06 | 2.4431E-05 | -1.1984E-05 | -4.2723E-06 | 5.6261E-06 |
| D | -8.2480E-07 | -8.5384E-07 | -7.6642E-07 | 8.1628E-07 | 8.2474E-07 | 3.7637E-07 |

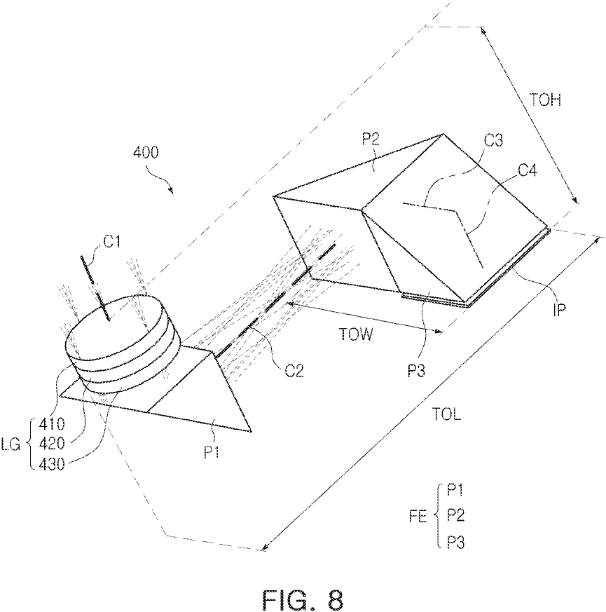

An optical imaging system according to a fourth embodiment will be described with reference to FIG. 8.

An optical imaging system 400 may include a lens group LG and an optical path converter FE. A configuration of the optical imaging system 400 is not limited to the lens group LG and the optical path converter FE. For example, the optical imaging system 400 may further include a filter IF disposed between the optical path converter FE and an imaging plane IP.

The lens group LG may include a plurality of lenses. For example, the lens group LG may include a first lens 410, a second lens 420, and a third lens 430, sequentially arranged from an object side. A configuration of the lens group LG is not limited to the first lens 410 to the third lens 430. For example, the lens group LG may further include a lens disposed inside the optical path converter FE (between a first prism P1 and a second prism P2 in reference to FIG. 8).

The first lens 410 may have positive refractive power. The first lens 410 may have a convex object side surface and a convex image side surface. The second lens 420 may have negative refractive power. The second lens 420 may have a concave object side surface and a concave image side surface. The third lens 430 may have positive refractive power. The third lens 430 may have a convex object side surface and a convex image side surface.

The optical path converter FE may include a plurality of prisms (P1, P2, and P3). For example, the optical path converter FE may be comprised of a first prism P1, a second prism P2, and a third prism P3. The first prism P1 to the third prism P3 may be disposed between the lens group LG and the imaging plane IP.

The first prism P1 to the third prism P3 may be configured to convert an optical path of the lens group LG. In more detail, the first prism P1 to the third prism P3 may convert an optical path of incident light in a direction intersecting a first optical axis C1 or parallel to the first optical axis C1. For example, the first prism P1 may reflect light incident along the first optical axis C1 in a direction of a second optical axis C2, the second prism P2 may reflect light incident along the second optical axis C2 in a direction of a third optical axis C3, and the third prism P3 may reflect light incident along the third optical axis C3 in a direction of a fourth optical axis C4 (i.e., in a direction of the imaging plane).

The first to third prisms P1 to P3 may be configured to reflect incident light in a direction intersecting the incident light. For example, the second optical axis C2 may be formed in a direction intersecting the first optical axis C1, the third optical axis C3 may be formed in a direction intersecting the second optical axis C2, and the fourth optical axis C4 may be formed in a direction intersecting the third optical axis C3.

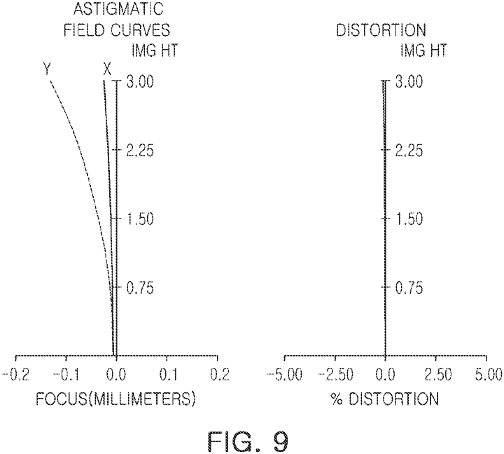

Table 7 illustrates lens characteristics of the optical imaging system according to the present embodiment, and Table 8 illustrates aspheric surface values of the optical imaging system according to the present embodiment. FIG. 9 is an aberration curve of the optical imaging system 400 according to the present embodiment.

TABLE 7

| Surface No. | Curvature Radius | Thickness/ Distance | Glass code | Y Semi-Aperture | X Semi-Aperture | Component |
|---|---|---|---|---|---|---|
| S1 | 7.6294 | 1.2150 | 743972.4485 | 3.2609 | 3.2609 | 1st Lens |
| S2 | -117.7929 | 0.3000 | | 3.2504 | 3.2504 | |
| S3 | -10.2950 | 0.3200 | 637777.3464 | 3.2479 | 3.2479 | 2nd Lens |
| S4 | 6.8799 | 0.5688 | | 3.2040 | 3.2040 | |
| S5 | 117.5235 | 1.0962 | 743972.4485 | 3.2118 | 3.2118 | 3rd Lens |
| S6 | -11.0483 | 0.5000 | | 3.1858 | 3.1858 | |
| S7 | infinity | 3.1500 | 721743.2950 | 3.0000 | 4.0000 | 1st Prism |
| S8 | infinity | 3.1500 | 721743.2950 | 4.2426 | 4.0000 | |
| S9 | infinity | 14.0742 | | 3.0000 | 4.0000 | |
| S10 | infinity | 4.0000 | 721743.2950 | 3.0000 | 4.0000 | 2nd Prism |
| S11 | infinity | 4.0000 | 721743.2950 | 3.0000 | 5.6569 | |
| S12 | infinity | 0.1000 | | 3.0000 | 4.0000 | |
| S13 | infinity | 3.0000 | 721743.2950 | 2.8000 | 3.8000 | 3rd Prism |
| S14 | infinity | 3.0000 | 721743.2950 | 3.9598 | 3.8000 | |
| S15 | infinity | 0.3000 | | 2.8000 | 3.8000 | |
| S16 | infinity | 0.2100 | 518274.6417 | 3.0000 | 4.0000 | Filter |
| S17 | infinity | 1.0000 | | 2.9933 | 2.9933 | |
| S18 | infinity | 0.0066 | | 3.0061 | 3.0061 | Imaging plane |

TABLE 8

| | | | | | | |
|---|---|---|---|---|---|---|
| Surface No. | S1 | S2 | S3 | S4 | S5 | S6 |
| K | 0.0000E+00 | 0.0000E+00 | 0.0000E+00 | 2.1678E+00 | 0.0000E+00 | 0.0000E+00 |
| A | -7.4221E-04 | 8.2934E-04 | 4.0013E-03 | -2.7423E-03 | -2.7352E-03 | -4.2059E-04 |
| B | -8.9399E-06 | 2.4474E-05 | -3.1930E-04 | 1.8195E-05 | 2.8005E-04 | 7.0287E-05 |
| C | 4.4126E-06 | 4.2472E-06 | 2.4431E-05 | -1.1984E-05 | -4.2723E-06 | 5.6261E-06 |
| D | -8.2480E-07 | -8.5384E-07 | -7.6642E-07 | 8.1628E-07 | 8.2474E-07 | 3.7637E-07 |

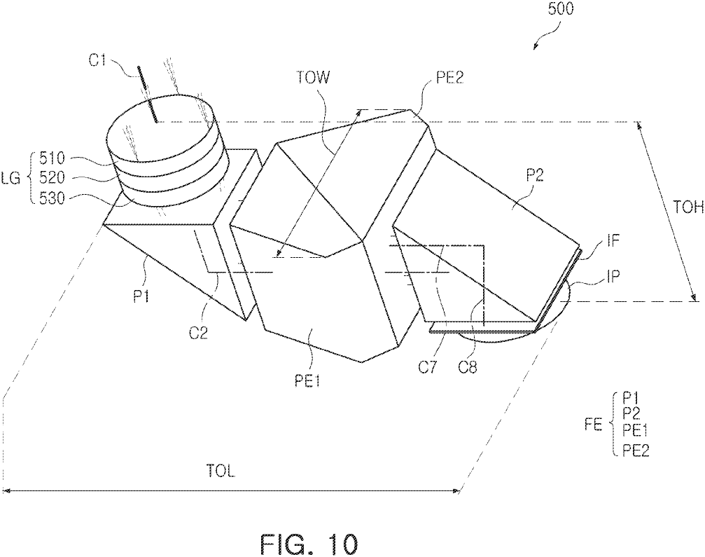

An optical imaging system according to a fifth embodiment will be described with reference to FIG. 10.

An optical imaging system 500 may include a lens group LG and an optical path converter FE. A configuration of the optical imaging system 500 is not limited to the lens group LG and the optical path converter FE. For example, the optical imaging system 500 may further include a filter IF disposed between the optical path converter FE and an imaging plane IP.

The lens group LG may include a plurality of lenses. For example, the lens group LG may include a first lens 510, a second lens 520, and a third lens 530, sequentially arranged from an object side. A configuration of the lens group LG is not limited to the first lens 510 to the third lens 530. For example, the lens group LG may further include a lens disposed inside the optical path converter FE (between a first prism P1 and a second prism P2 in reference to FIG. 10).

The first lens 510 may have positive refractive power. The first lens 510 may have a convex object side surface and a convex image side surface. The second lens 520 may have negative refractive power. The second lens 520 may have a concave object side surface and a concave image side surface. The third lens 530 may have positive refractive power. The third lens 530 may have a convex object side surface and a convex image side surface.

The optical path converter FE may include a plurality of prisms (P1 and P2) and a plurality of Pechan prisms (PE1 and PE2). For example, the optical path converter FE may include a first prism P1, a second prism P2, a first Pechan prism PE1, and a second Pechan prism PE2. The first prism P1, the second prism P2, the first Pechan prism PE1, and the second Pechan prism PE2 may be disposed between the lens group LG and the imaging plane IP.

The first prism P1, the second prism P2, the first Pechan prism PE1, and the second Pechan prism PE2 may be configured to convert an optical path of the optical imaging system. When commanded, the first prism P1 and the second prism P2 may convert an optical path of incident light in a direction intersecting a first optical axis C1 or parallel to the first optical axis C1, and the first Pechan prism PE1 and the second Pechan prism PE2 may be configured to reflect light emitted from the first prism P1 in a plane direction intersecting the first optical axis C1, respectively, twice or more.

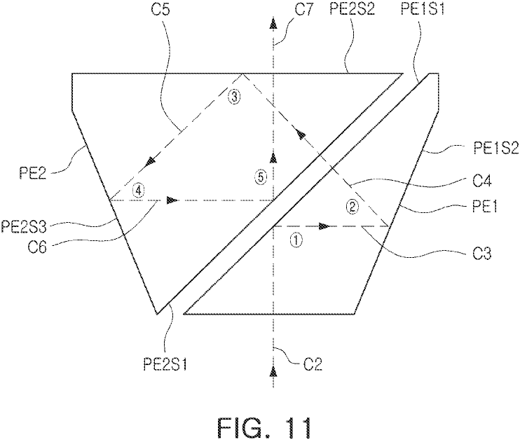

An optical path in the Pechan prisms illustrated in FIG. 10 will be described with reference to FIG. 11.

The first Pechan prism PE1 and the second Pechan prism PE2 may be configured to form a long optical path in a limited space. For example, the first Pechan prism PE1 and the second Pechan prism PE2 may be configured to reflect incident light at least twice or more. As another example, the second Pechan prism PE2 may include a surface capable of reflecting light while allowing the light to be incident or emitted. As a specific example, a first surface PE2S1 of the second Pechan prism PE2 may allow light to be incident and may reflect light, and a second surface PE2S2 of the second Pechan prism PE2 may reflect light and may emit the light.

The first and second Pechan prisms PE1 and PE2 configured as described above may reflect light emitted from the first prism P1 five times or more. For example, a first surface PE1S1 of the first Pechan prism PE1 may reflect light incident along a second optical axis C2 in a direction of a third optical axis C3, and a second surface PE1S2 of the first Pechan prism PE1 may reflect light incident along the third optical axis C3 in a direction of a fourth optical axis C4. As another example, the second surface PE2S2 of the second Pechan prism PE2 may reflect light incident along the fourth optical axis C4 in a direction of a fifth optical axis C5, a third surface PE2S3 of the second Pechan prism PE2 may reflect light incident along the fifth optical axis C5 in a direction of a sixth optical axis C6, and the first surface PE2S1 of the second Pechan prism PE2 may reflect light incident along the sixth optical axis C6 in a direction of a seventh optical axis C7.

Therefore, according to the present embodiment, an optical path having a considerable length may be formed even in a limited space by the first and second Pechan prisms PE1 and PE2, to realize an optical imaging system having a long focal length.

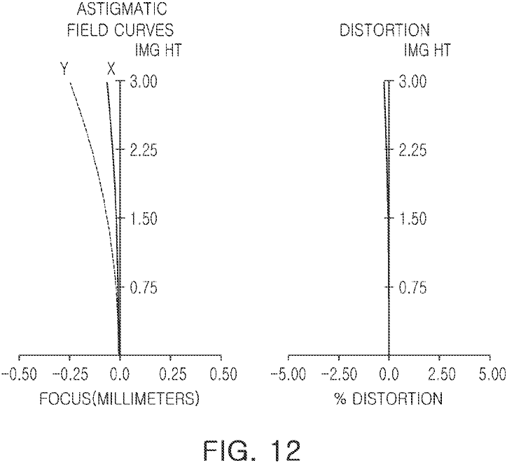

Table 9 illustrates lens characteristics of the optical imaging system according to the present embodiment, and Table 10 illustrates aspheric surface values of the optical imaging system according to the present embodiment. FIG. 12 is an aberration curve of the optical imaging system 500 according to the present embodiment.

TABLE 9

| Surface No. | Curvature Radius | Thickness/ Distance | Glass code | Y Semi-Aperture | X Semi-Aperture | Component |
|---|---|---|---|---|---|---|
| S1 | 7.6294 | 1.2150 | 743972.4485 | 2.7273 | 2.7273 | 1st Lens |
| S2 | -117.7929 | 0.3000 | | 2.6684 | 2.6684 | |
| S3 | -10.2950 | 0.3200 | 637777.3464 | 2.6610 | 2.6610 | 2nd Lens |
| S4 | 6.8799 | 0.5688 | | 2.6321 | 2.6321 | |
| S5 | 117.5235 | 1.0962 | 743972.4485 | 2.6507 | 2.6507 | 3rd Lens |
| S6 | -11.0483 | 0.5000 | | 2.6979 | 2.6979 | |
| S7 | infinity | 3.0000 | 721743.2950 | 3.0000 | 3.0000 | 1st Prism |
| S8 | infinity | 3.0000 | 721743.2950 | 4.2426 | 3.0000 | |
| S9 | infinity | 1.0000 | | 3.0000 | 3.0000 | |
| S10 | infinity | 3.2000 | 721743.2950 | 3.2000 | 3.2000 | 1st Pechan Prism |
| S11 | infinity | 4.5255 | 721743.2950 | 3.2000 | 4.5255 | |
| S12 | infinity | 3.2000 | 721743.2950 | 3.2000 | 3.4637 | |
| S13 | infinity | 0.1000 | | 3.2000 | 3.2000 | |
| S14 | infinity | 3.2000 | 721743.2950 | 3.2000 | 3.2000 | 2nd Pechan Prism |
| S15 | infinity | 6.4000 | 721743.2950 | 3.2000 | 4.5255 | |
| S16 | infinity | 4.5255 | 721743.2950 | 3.2000 | 3.4637 | |
| S17 | infinity | 4.5255 | 721743.2950 | 3.2000 | 4.5255 | |
| S18 | infinity | 1.0000 | | 3.2000 | 3.2000 | |
| S19 | infinity | 3.0000 | 721743.2950 | 3.0000 | 3.0000 | 2nd Prism |
| S20 | infinity | 3.0000 | 721743.2950 | 4.2426 | 3.0000 | |
| S21 | infinity | 0.3000 | | 3.0000 | 3.0000 | |
| S22 | infinity | 0.2100 | 518274.6417 | 2.9000 | 3.2000 | Filter |
| S23 | infinity | 0.7167 | | 2.9885 | 2.9885 | |
| S24 | infinity | 0.0066 | | 3.0078 | 3.0078 | Imaging plane |

TABLE 10

| | | | | | | |
|---|---|---|---|---|---|---|
| Surface No. | S1 | S2 | S3 | S4 | S5 | S6 |
| K | 0.0000E+00 | 0.0000E+00 | 0.0000E+00 | 2.1678E+00 | 0.0000E+00 | 0.0000E+00 |
| A | -7.4221E-04 | 8.2934E-04 | 4.0013E-03 | -2.7423E-03 | -2.7352E-03 | -4.2059E-04 |
| B | -8.9399E-06 | 2.4474E-05 | -3.1930E-04 | 1.8195E-05 | 2.8005E-04 | 7.0287E-05 |
| C | 4.4126E-06 | 4.2472E-06 | 2.4431E-05 | -1.1984E-05 | -4.2723E-06 | 5.6261E-06 |
| D | -8.2480E-07 | -8.5384E-07 | -7.6642E-07 | 8.1628E-07 | 8.2474E-07 | 3.7637E-07 |

Tables 11 to 13 show optical characteristic values and conditional expression values of the optical imaging systems according to the first to fifth embodiments.

TABLE 11

| | 1^{st} Embodiment | 2^{nd} Embodiment | 3^{rd} Embodiment | 4^{th} Embodiment | 5^{th} Embodiment |
|---|---|---|---|---|---|
| f1 | 9.6711 | 9.6711 | 9.6711 | 9.6711 | 9.6711 |
| f2 | -6.4195 | -6.4195 | -6.4195 | -6.4195 | -6.4195 |
| f3 | 13.6239 | 13.6239 | 13.6239 | 13.6239 | 13.6239 |
| TTL | 34.1221 | 43.3443 | 36.6372 | 39.9908 | 48.9097 |
| BFL | 30.6221 | 39.8443 | 33.1372 | 36.4908 | 45.4097 |
| f | 30.0000 | 30.0000 | 30.0000 | 30.0000 | 30.0000 |
| IMG HT | 3.0000 | 3.0000 | 3.0000 | 3.0000 | 3.0000 |

TABLE 12

| | 1^{st} Embodiment | 2^{nd} Embodiment | 3^{rd} Embodiment | 4^{th} Embodiment | 5^{th} Embodiment |
|---|---|---|---|---|---|
| TOH | 10.50 | 11.60 | 11.60 | 10.30 | 11.10 |
| TOL | 30.60 | 21.80 | 31.80 | 29.40 | 22.00 |
| TOW | 8.80 | 16.10 | 8.80 | 13.80 | 11.70 |
| PEH | N/A | N/A | N/A | N/A | 6.40 |
| PEL | N/A | N/A | N/A | N/A | 7.80 |
| PEW | N/A | N/A | N/A | N/A | 12.80 |
| DPE12 | N/A | N/A | N/A | N/A | 0.10 |
| DPEP | N/A | N/A | N/A | N/A | 0.50 |
| DLRP1 | 0.50 | 0.50 | 0.50 | 0.50 | 0.50 |
| P1W | 8.00 | 8.00 | 8.00 | 8.00 | 6.00 |
| P1H | 6.00 | 6.00 | 6.00 | 6.00 | 6.00 |
| DPA | N/A | 0.10 | N/A | 0.10 | N/A |

TABLE 13

| Conditional Expression | 1^{st} Embodiment | 2^{nd} Embodiment | 3^{rd} Embodiment | 4^{th} Embodiment | 5^{th} Embodiment |
|---|---|---|---|---|---|
| TTL/f | 1.1374 | 1.4448 | 1.2212 | 1.3330 | 1.6303 |
| BFL/TTL | 0.8974 | 0.9193 | 0.9045 | 0.9125 | 0.9284 |
| f1/f | 0.3224 | 0.3224 | 0.3224 | 0.3224 | 0.3224 |
| f2/f | -0.2140 | -0.2140 | -0.2140 | -0.2140 | -0.2140 |
| f3/f | 0.4541 | 0.4541 | 0.4541 | 0.4541 | 0.4541 |
| BFL/f | 1.0207 | 1.3281 | 1.1046 | 1.2164 | 1.5137 |
| (Nd1+Nd2+Nd3)/3 | 1.7086 | 1.7086 | 1.7086 | 1.7086 | 1.7086 |
| f/IMG HT | 10.0000 | 10.0000 | 10.0000 | 10.0000 | 10.0000 |
| TTL/BFL | 1.1143 | 1.0878 | 1.1056 | 1.0959 | 1.0771 |

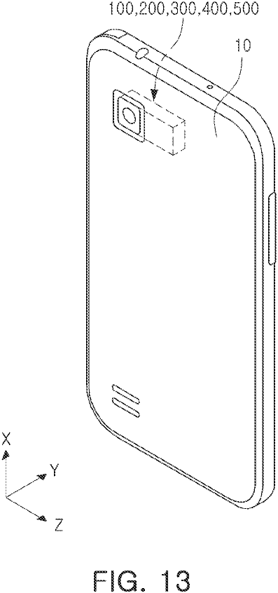

The optical imaging systems 100, 200, 300, 400, and 500 according to the present specification may be mounted in a portable electronic device. For example, one or more of the optical imaging systems according to the first to fifth embodiments may be mounted on a rear surface or a front surface of a portable terminal 10 as illustrated in FIG. 13.

According to the present disclosure, an optical imaging system that may be mounted on a portable electronic device while enlarging an image sensor may be provided.

In addition, according to the present disclosure, a degree of freedom of arrangement of an image sensor may increase to reduce an external size of an optical imaging system.

While specific example embodiments have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a lens group including at least one lens forming a first optical axis; and
an optical path converter reflecting light emitted from the lens group to form an image on an imaging plane,
wherein a maximum distance from an object side surface of a frontmost lens, disposed closest to an object side, among the lens group, to the imaging plane, in a first optical axis direction is 11.0 mm or less.

2. The optical imaging system of claim 1, wherein the lens group comprises a first lens, a second lens, and a third lens, sequentially arranged from the object side.

3. The optical imaging system of claim 2, wherein the first lens has positive refractive power.

4. The optical imaging system of claim 2, wherein the second lens has negative refractive power.

5. The optical imaging system of claim 2, wherein the second lens has a concave object side surface.

6. The optical imaging system of claim 2, wherein the second lens has a concave image side surface.

7. The optical imaging system of claim 2, wherein the third lens has positive refractive power.

8. The optical imaging system of claim 1, wherein a distance of an optical path from an image side surface of a rearmost lens, a lens disposed closest to the imaging plane, among the lens group, to the imaging plane is 20.0 mm to 50.0 mm.

9. The optical imaging system of claim 1, satisfying the following conditional expression:
0.86 < BFL/TTL < 0.96,
where TTL is a distance of an optical path from the object side surface of the frontmost lens to the imaging plane, and BFL is a distance of an optical path from an image side surface of a rearmost lens among the lens group to the imaging plane.

10. The optical imaging system of claim 1, wherein the first optical axis direction and an optical axis of the imaging plane are substantially parallel.

11. An optical imaging system comprising:
a lens group including at least one lens; and
an optical path converter disposed between the lens group and an imaging plane, and configured to reflect light emitted from the lens group one or more times, to form an image on the imaging plane by the light,
wherein 8 < f/IMG HT < 12,
where f is a focal length of the optical imaging system, and IMG HT is a height of the imaging plane.

12. The optical imaging system of claim 11, wherein the lens group comprises a first lens, a second lens, and a third lens, sequentially arranged from an object side.

13. The optical imaging system of claim 12, satisfying the following conditional expression:
0.30 <f1/f< 0.40,
where f1 is a focal length of the first lens.

14. The optical imaging system of claim 12, satisfying the following conditional expression:
-0.28 < f2/f < -0.18,
where f2 is a focal length of the second lens.

15. The optical imaging system of claim 12, satisfying the following conditional expression:
0.40 < f3/f < 0.50,
where f3 is a focal length of the third lens.

16. The optical imaging system of claim 12, satisfying the following conditional expression:
1.68 < (Nd1 +Nd2+Nd3)/3 < 1.74,
where Nd1 is a refractive index of the first lens, Nd2 is a refractive index of the second lens, and Nd3 is a refractive index of the third lens.

17. The optical imaging system of claim 11, satisfying the following conditional expression:
0.86 < BFL/TTL < 0.96
where, TTL is a distance of an optical path from an object side surface of a frontmost lens among the lens group to the imaging plane, and BFL is a distance of an optical path from an image side surface of a rearmost lens among the lens group to the imaging plane.

18. The optical imaging system of claim 11, wherein a maximum distance from an object side surface of a frontmost lens, disposed closest to an object side, among the lens group, to the imaging plane, in an optical axis direction of the lens group is 11.0 mm or less.

19. An optical imaging system comprising:
a lens group including at least one lens; and
an optical path converter disposed between the lens group and an imaging plane, and configured to reflect light emitted from the lens group two or more times, to form an image on the imaging plane by the light,
wherein 1.0 < BFL/f < 1.6,
where f is a focal length of the optical imaging system, and BFL is a distance of an optical path from an image side surface of a rearmost lens among the lens group to the imaging plane.

20. The optical imaging system of claim 19, wherein an optical axis of the at least one lens and an optical axis of the imaging plane are substantially parallel.

21. The optical imaging system of claim 19, satisfying the following conditional expression:
0.86 < BFL/TTL < 0.96
where, TTL is a distance of an optical path from an object side surface of a frontmost lens among the lens group to the imaging plane, and BFL is a distance of an optical path from an image side surface of a rearmost lens among the lens group to the imaging plane.
